(19) United States
(12) Patent Application Publication
(10) Pub. No.: US 2024/0418288 A1
(43) Pub. Date: Dec. 19, 2024

(54) SYSTEM FOR CONTROLLING FLUID DISTRIBUTION IN A HYDRAULIC CIRCUIT

(71) Applicant: BONTAZ CENTRE, MARNAZ (FR)

(72) Inventors: Damien DUMANGE, MARIGNIER (FR); Guillaume MOLLER, VAULX (FR); Quentin DURANDO, ARENTHON (FR); Matthieu LAPERCHE, MARNAZ (FR)

(21) Appl. No.: 18/703,844

(22) PCT Filed: Oct. 20, 2022
(86) PCT No.: PCT/FR2022/051984

§ 371 Date: Apr. 23, 2024

(30) Foreign Application Priority Data
Oct. 25, 2021 (FR) FR2111328

(51) Int. Cl. F16K 31/04; F16K 31/53; F16K 37/00

(52) U.S. Cl. CPC F16K 31/042; F16K 31/535; F16K 37/0041

(57) ABSTRACT

A system for controlling the distribution of a fluid in a hydraulic circuit, including:-a motor; a plurality of d rotary distributors of the fluid, each distributor including a body, rotating in a plane, said body including at least one inlet and at least one outlet, the sum of the number of inlets and the number of outlets being greater than or equal to 3, a mechanical output axis of each distributor extending in a direction perpendicular to the plane; a plurality of d gear trains, each train ensuring the transmission of the movement of the motor to one of the rotary distributors, called associated rotary distributor, each gear train, including an actuator, for engaging or disengaging the associated rotary distributor, relative to the gear train, the actuator moving along the axis defined by the mechanical output axis of the distributor.

### TECHNICAL FIELD AND PRIOR ART

The invention relates to the field of managing a flow of fluid, for example water, in a hydraulic circuit, for example a cooling circuit of a vehicle.

Currently, controlling the water flow in a vehicle cooling circuit can be achieved by:
A set of motorised actuators and On/Off valves;
or multi inlet-multi outlet valves (of the “Octovalve” type of Tesla);
or independent regulation modules with one or more actuators.

There is a problem of finding a simpler control system or device.

There is also the problem of finding a device or system for managing or controlling the distribution of a fluid in a hydraulic circuit, which is simpler than known systems, and which can be applied to various fluids.

There is also a problem of finding a new device for distributing a fluid, capable of being integrated into a distribution system, and capable of being applied to various fluids.

### DESCRIPTION OF THE INVENTION

The invention firstly relates to a system for controlling the flow of at least one fluid in a hydraulic circuit, and/or a system for actuating at least one distributor of at least one fluid in a hydraulic circuit, including:
a motor, for example a motor, for example a brushless motor or a stepper motor;
one or more distributor(s) (D₁-D_{d}) of said fluid;
one or more (d) gear trains, each train ensuring the transmission of the movement of the motor to one of the distributors, each gear train including means for directly engaging or disengaging the associated distributor or a gear of this train.

For example, each distributor includes a body, rotating in a plane (YZ), said body including at least one inlet and at least one outlet, the sum of the number of inlets and the number of outlets being for example greater than or equal to 3, a mechanical output and/or drive axis of the distributor extending in a direction perpendicular to said plane.

For example, each gear train may include means, including an actuator, for engaging or disengaging the associated rotary distributor, relative to the gear train, said actuator moving, or being capable of moving or being able to move, along the axis defined by the mechanical output axis of the distributor.

Such a system is simpler than known systems since the same motor can actuate different distributors.

Each gear train may include:
a first stage of gears (E_{1.1}-E_{1.d}), each gear of which is driven by said motor;
a second stage of gears (E_{2.1}-E_{2.d}), each gear of which is driven by the first stage.

For example:
in the first stage of gears (E_{1.1}-E_{1.d}), each gear of this first stage can be driven by said motor and be associated with a disengageable shaft (A_{1.1}-A_{1.d}) and/or with disengagement means;
a second stage of gears (E_{2.1}-E_{2.d}), each gear of which is driven by a gear, or a shaft associated with a gear, of the first stage of gears.

A system according to the invention allows to direct the flow of a fluid, for example water, via distributors controlled independently by the same motor. For example, this fluid comes from p pumps is distributed using m inlets (the sum of the number of inlets of all the distributors) and n outlets (the sum of the number of outlets of all the distributors in the system).

According to particular embodiments:
each distributor (Dᵢ) may include nₑᵢ inlets and nₛᵢ outlets;
and/or each distributor (Dᵢ) may include or be associated with a position sensor (C₁-C_{d});
and/or the system may include electronic means for controlling the motor; in even more specific embodiments, these electronic means are capable of:
controlling the motor according to a signal or signals from one or more of said position sensors (C₁-C_{d}).
and/or of:
receiving an operating mode instruction;
determining a target movement of each of the d distributors;
controlling the motor according to the target movement of each of the distributors.

According to other particular embodiments, each tree:
is associated with a solenoid to engage or disengage it;
and/or can be held in the rest position by a compression spring (R₁, . . . . R_{d}).

Each rotary distributor, or the system that drives it, may include:
a rotating distributor body, including at least one inlet and at least one outlet, the sum of the number of inlets and the number of outlets being for example greater than or equal to 3;
and/or an axis of rotation which rotates said body of the distributor around said axis (XX′);
means for driving said axis of rotation;
and/or return means to maintain the axis of rotation in an engaged or disengaged rest position relative to the drive means; for example these return means include a spring held in compression between an axis connected to the rotary distributor and the axis of rotation which drives said body; the actuator is preferably capable, when actuated, of compressing the return means (Rᵢ);
and/or means for disengaging or engaging said axis from its rest position, relative to the drive means.

The means for engaging or disengaging said axis of the drive means may for example include means of the electromagnetic actuator or pneumatic actuator or hydraulic actuator type.

In the case of means of the electromagnetic actuator type, these means include for example a coil and a plunger which interacts with the field generated by the coil when a current flows therethrough, to compress the return means.

The axis of rotation which drives said body and the means for driving said axis can for example each include a toothed wheel forming a gear with a vertical axis.

Such a rotary distributor may further include braking means to brake the distributor when it is disengaged.

A fluid distribution system according to the invention, and/or a system for actuating at least one distributor of at least one fluid, in a hydraulic circuit, may include:
at least one pump;
a system for controlling the distribution of said fluid according to the invention, as defined above or in the present application.

The invention also relates to a vehicle including a thermal and/or electric engine, at least one hydraulic circuit and at least one fluid distribution system in this hydraulic circuit according to the invention, as defined above or in this application.

The invention also relates to a method for controlling the distribution of at least one fluid in a hydraulic circuit, implementing a system according to the invention, as described above or in the present application.

Preferably, such a method includes:
determining one or more distributors to be actuated;
and/or actuating said distributor(s) using the motor.

An instruction or a control signal can be previously received, defining an operating mode, or a combination of position(s) of the distributor(s) to be reached to distribute the fluid according to what is desired or defined by the instruction or signal.

The position of one or more distributors can be known by a measurement, for example by one or more position sensor(s) associated with one or more distributor(s).

According to one embodiment, the fluid may be water, but other fluids May be involved, for example oil or glycol or a gas, for example air or hydrogen.

In a device or a method according to the invention, the hydraulic circuit can for example be a distribution circuit for a fluid in a cooling circuit or an oil or hydrogen or air distribution circuit of a vehicle or a device, for example of a domestic type such as a heat pump.

According to another aspect, the invention also relates to a rotary distributor for dispensing a fluid, including:
a rotating distributor body, including at least one inlet and at least one outlet, the sum of the number of inlets and the number of outlets being greater than or equal to 3;
an axis of rotation which drives said body;
means for driving said axis;
return means for maintaining the axis of rotation in an engaged or disengaged rest position relative to the drive means; for example these return means include a spring held in compression between an axis connected to the rotary distributor and the axis of rotation which drives said body;
means for disengaging or engaging said axis from its rest position, relative to the drive means.

For example, this distributor includes a body, rotating in a plane (YZ), said body including at least one inlet and at least one outlet, the sum of the number of inlets and the number of outlets being for example greater than or equal to 3, a mechanical output and/or drive axis of the distributor extending in a direction perpendicular to said plane.

For example, this distributor may include means, including an actuator, for engaging or disengaging the rotary distributor, relative to the means for driving said axis, said actuator moving linearly, along the axis defined by the mechanical output axis of the distributor.

Such a rotary distributor can be used as part of a fluid distribution system according to the invention.

The means for engaging or disengaging said axis of the drive means may include means of the electromagnetic actuator or pneumatic actuator or hydraulic actuator type.

In the case of means of the electromagnetic actuator type, these means include a coil and a plunger which interacts with the field generated by the coil when a current flows therethrough, to compress the return means.

The axis of rotation which drives said body and the means for driving said axis can for example each include a toothed wheel forming a gear with a vertical axis.

Such a rotary distributor according to the invention may further include braking means for braking the distributor when it is disengaged.

### BRIEF DESCRIPTION OF THE DRAWINGS

FIG. 1 represents an exemplary embodiment of a system according to the invention;

FIG. 2 represents an example of production of a gear train in combination with a motor.

FIGS. 3A-3C represent an example of a rotary distributor which can be implemented in a system according to the invention;

FIG. 4 represents an exemplary embodiment of a mechanism for disengaging a distributor which can be implemented in a system according to the invention.

### DETAILED DESCRIPTION OF PARTICULAR EMBODIMENTS

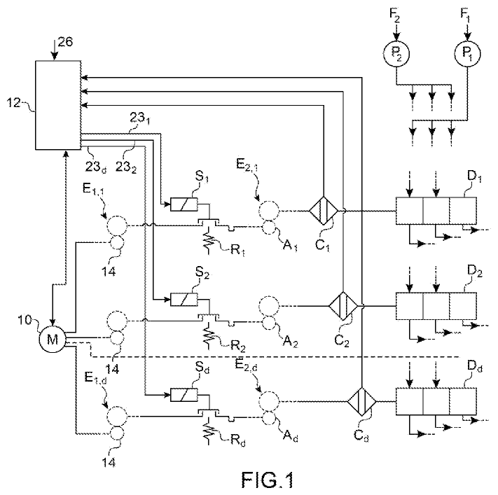

FIG. 1 represents an exemplary embodiment of a hydraulic circuit for distributing fluid(s) according to the invention or to which the invention can be applied.

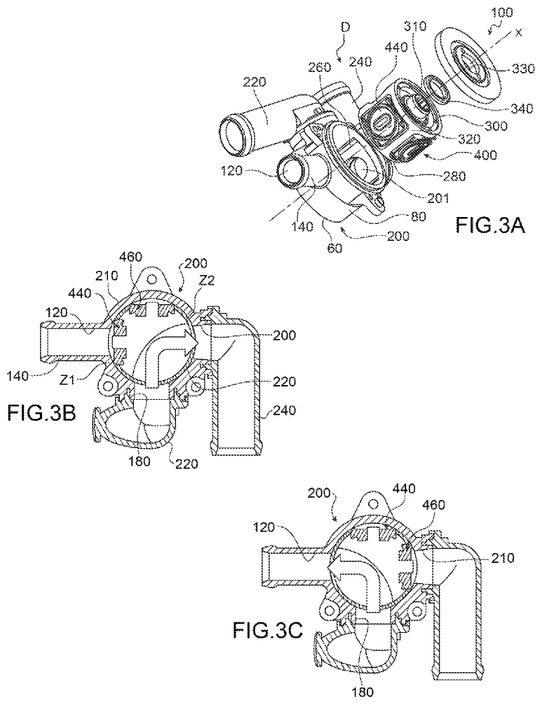

In this example, this circuit includes 2 pumps P1 and P2, each distributing a fluid F1, F2, but a different number of pump(s) and fluid(s) is part of the scope of the present application. The fluid(s) is/are distributed by rotary distributors Dᵢ. FIGS. 3A-3C are described below and represent an example of a rotary distributor Dᵢ that can be used in the context of the present invention.

A system for controlling the distribution of fluids in this hydraulic circuit includes a motor 10, preferably a brushless motor, which drives a central outlet shaft 14 coupled simultaneously to d gear trains (d>2).

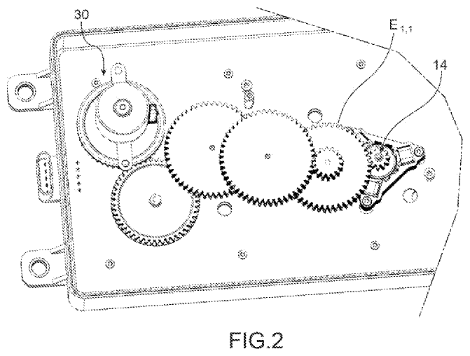

In FIG. 1, the shaft 14 is shown associated with different gear trains, but the latter are in fact disposed around the shaft 14 (as in the example of FIG. 2 for a gear train). Electronic control means 12, for example made in the form of a printed circuit board (“PCB”), control this motor 10. The gears of the different trains are preferably straight gears, with parallel axes.

Each gear train includes in this example a first gear (E_{1.1} . . . . E_{1.d}) of a first stage of gears.

Each of these gears E_{1.1} . . . . E_{1.d} for example rotates a shaft A1 . . . . A1 which can be engaged/disengaged independently of the others, using an actuator, for example of the electromagnetic (solenoid) or pneumatic or hydraulic type. In FIG. 1, electromagnetic (or solenoid) actuators S1, . . . . Sa are schematically shown but other types of actuators (hydraulic, pneumatic actuators) are possible. Each disengageable shaft can be held in the rest position for example by a compression spring R1, . . . . Rd. Each actuator can be controlled by the electronic control means 12.

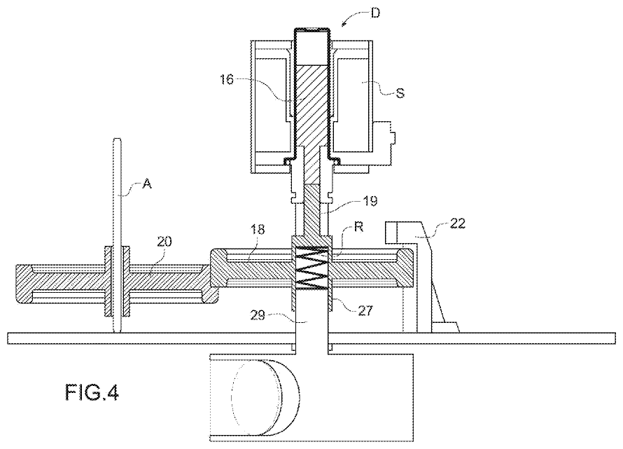

FIG. 4 is described below and represents an example of a rotary distributor Dᵢ with its electromagnetic type actuator, including a solenoid Sᵢ

In the exemplary embodiment illustrated in FIG. 1, the system includes a second stage of gears (E_{2.1} . . . . E_{2.d}). Each of these second stage gears can be connected to a disengageable shaft and drives a rotary distributor D1 . . . . D_{d}. These rotating distributors are therefore driven independently of each other.

It can be noted that the actuator can be associated with any of the toothed wheels or shafts of each gear train; in FIG. 1, it is the wheel which immediately precedes the distributor, but in FIG. 4 it is the wheel associated with the distributor itself. Any toothed wheel of each gear train can be associated with the engagement and disengagement means, which allows to disengage or engage the corresponding distributor.

Each of the d distributors can be associated with a position sensor C₁-C_{d} which allows, preferably at any time, to know the position of the distributor with which it is associated. A position signal is sent to the means 12.

Each rotary distributor Dᵢ can have nₑᵢ inlets (nₑᵢ >1) and nₛᵢ outlets (nₛᵢ>1), a distributor with a single inlet (nₑᵢ=1) including several outlets (nₛᵢ>2) and a distributor with a single outlet (nₛᵢ=1) including several inlets (nₑᵢ >1). The outlets are connected to conduits which bring the fluid to a given application, for example a cooling circuit or a circuit which must be supplied with oil or air (for example an air conditioning circuit) or with hydrogen (for example a fuel cell power supply circuit). In the example of FIG. 1, the distributor D1 has one inlet and 2 outlets, the distributor D2 has 2 inlets and one outlet, the distributor Da has 2 inlets and 3 outlets; any other combination of inlets/outlets can be achieved.

In FIG. 1, the outlets of the distributors are directed towards other organs of the hydraulic system; but, alternatively (not shown), one or more outlets of one or more distributors are directed towards one or more inlets of another or more other distributors.

An example of a rotary distributor that can be implemented in the context of the present invention is described in the application filed under number FR-202101137; its structure is recalled in FIGS. 3A-3C.

The fluid distribution system also includes a number p (p>1) of pump(s), connected to the different distributors according to an architecture which is specific to the fluid distribution system considered.

Each of the d actuators S₁, . . . . S_{d} can be controlled by means 12 depending on the position of the different distributors; this position can be known thanks to the signal received by these means 12 from the corresponding position sensor.

In operation, the means 12 can receive from the vehicle an operating mode instruction 26, each operating mode is defined by the engaged or disengaged state of each distributor and by the opening and closing positions of all the inlets and of all the outlets of the selected (or engaged) distributors. When all the distributors have the same number x of possible positions, the total number of modes is equal to x^{t}. The data relating to each operating mode can be stored in storage means associated with the means 12 and the position of each distributor can be known by the sensors Cᵢ. The selection of an operating mode therefore defines an engaged or disengaged state of each distributor and a position for each engaged distributor.

Optionally, the storage means can store (or the means 12 can calculate):
in what direction and with what angular movement each selected distributor can be actuated to make it evolve from a state defined by a certain combination of its inlets/outlets to another state defined by another combination of its inlets/outlets;
and/or the order wherein the selected distributors must be engaged; all can be engaged simultaneously or sequentially (and in a certain order) or a part of these distributors can be engaged simultaneously, the other part being engaged sequentially (again in a certain order).

When it is desired to drive one or more distributors in a direction opposite to the direction wherein this or these distributor(s) was (were) previously driven, then the direction of rotation of the motor 10 is reversed. The distributor(s) whose direction of rotation is not reversed can be disengaged. When it is wished to drive one or more distributors in a direction opposite to the direction wherein one or more other distributor(s) is/are to be driven, then it is possible to disengage the latter.

Depending on the selected operating mode, these means 12 can actuate the engagement or disengagement means of the selected distributor(s), and actuate this or these distributors by determining for example the direction and the angular movement of each of the concerned distributors, as well as the order or sequence of activation (sequential or simultaneous as described above).

The motor 10 is then powered, and depending on the determined sequence and the position of each of the d distributors, the axes are engaged (or not) sequentially or simultaneously until each of the d distributors has reached the desired position.

This system therefore allows to replace a product composed of several valves controlled by as many brushless actuators by a set of hydraulic distributors controlled by a single motor 10, for example brushless or stepped motor, and an engagement and disengagement mechanism associated with each of the distributors.

The means 12, produced for example in the form of a printed circuit board, may include for example a processor or a microprocessor programmed to control the engagement/disengagement means of each distributor and the motor 10 according to a plurality of modes of operation as defined above and/or to calculate the actuation of one or more of the distributors according to an operating mode selected by an operator or a vehicle.

FIG. 2 shows an example of a single gear train in combination with a motor. The axis 14 of the motor, as well as the first stage E_{1.1} are seen in this figure. Other gear trains identical or similar to that shown in FIG. 2 can be arranged around the motor.

FIGS. 3A-3C represent an example of a rotary distributor which can be implemented in a system according to the invention.

It includes one inlet and two outlets, but it is understood that it can have one or more inlets and one or more outlets.

This distributor includes a housing 200 or valve body, of essentially cylindrical shape of revolution around an axis X, and a central part 400, designated core, mounted in the housing 200 and able to rotate in the housing 200.

In the example shown, the housing 200 includes a bottom 60 and a side wall 80 substantially cylindrical made in one piece, and a cover 100 to close the housing. The cover 100 is for example secured to the housing 200 by welding, for example by ultrasonic welding.

The housing 200 includes an orifice 180, called the supply orifice, formed in the side wall 80 and a supply conduit 220, for example welded to the base of the orifice 180 and intended for connection to a source of fluid, for example a pump such as one of the pumps P1, P2 in FIG. 1. On either side of this inlet orifice 180, the housing 200 also includes:
a first outlet orifice 210 formed in the side wall 80, extending by a conduit 240 (or distribution conduit) intended to bring the liquid to a given zone, for example a zone to be cooled;
and a second outlet orifice 120 extended by a conduit 140, (or distribution conduit) intended to bring the liquid to another given zone.

These outlet orifices are intended to distribute a fluid when either one of them is positioned opposite the inlet of a distribution conduit. Either one of these outlet orifices is brought in front of this inlet of a distribution conduit by rotating the distributor around the axis XX′ and the fluid then leaves the distributor with a direction in a plane perpendicular to the axis XX′. There may be several distribution conduits and several corresponding inlets of these conduits, all disposed in this plane perpendicular to the axis XX′. In other words, this type of distributor distributes one or more fluids in this plane, that is to say that the fluid(s) thus distributed leave the distributor preferably having a flow direction which is in this plane perpendicular to this axis XX′. Likewise, the fluid to be distributed enters the distributor with a flow direction which is preferably in this same plane perpendicular to this axis XX′.

The conduits 140 and 240 are for example welded on the base of the orifices 210 and 120 respectively. The housing 200 defines a hydraulic chamber 260. The outlet orifices 120 and 210 are distributed angularly on the side wall around the axis X on either side of the supply orifice 180.

The core 400 is intended to be mounted in the hydraulic chamber and is capable of rotating around the axis X. It includes two end faces 280, 300 and a lateral surface 320. It includes in turn at least one conduit which allows to connect an inlet 201 and an outlet 203 (as can be understood from FIGS. 3B and 3C, the inlet 201, depending on the position of the core around the axis XX, can become the outlet, and vice versa for the outlet 203).

The end face 280 is facing the bottom of the housing and the end face 300 is facing the cover. The end face 300 includes a recessed cavity 310 intended to receive the end of a shaft of an actuator, shaft preferably aligned along the axis X (or mechanical and/or drive axis of the distributor). The cover 100 includes an opening 330 facing the recess 310 to allow coupling with the shaft. Alternatively, the end face 300 includes a projecting coupling member intended to penetrate into a recess formed in the shaft of the actuator. A seal 340 is advantageously provided between the end face 300 and the cover bordering the cavity 310 to prevent fluid leaks.

The core 400 may also include a first seal 440 intended to close the outlet orifice 120, when they face each other, and optionally a second seal 460 and intended to close the outlet orifice 210, when they face each other. The first seal 440 and the second seal 460 are of identical or similar shape, as well as their mounting on the core.

As already explained above, this distributor allows to distribute fluid laterally, depending on the orientation, around the vertical axis XX′, of the core of the distributor: the, or each of the, fluid(s) which is/are thus distributed, at the outlet of the distributor, has a flow direction in the plane perpendicular to the axis XX′.

Thus, in FIG. 3B, in a 1st position, the distributor brings the fluid towards the outlet 210; in FIG. 3C, in a 2nd position, after having rotated around the axis XX′, the distributor brings the fluid towards the outlet 120.

FIG. 4 represents a rotary distributor D, for example of the type described above in connection with FIGS. 3A-3C, provided with an output axis 29 (or mechanical output and/or drive axis), and its actuator, here of the electromagnetic type; the latter includes a solenoid S which, when actuated, actuates a plunger 16 along the axis XX′ in the direction of the axis 29, a movement which will compress the spring R; the plunger has the magnetic properties to interact with the field generated when a current passes through the solenoid and thus be brought towards the rotary distributor D. The plunger thus pushes an axis 19 integral with a toothed wheel 18, which meshes then with another wheel 20, mounted on a shaft A, which can itself be actuated by the motor 10, or by drive means (this wheel is itself part of a gear train) driven by the motor 10. The wheel 18 can be extended in its central part by a cylindrical wall 27, which includes means (keys for example), or clutch or means forming a clutch, which allow it to be coupled to the output axis 29 of the distributor, while allowing a translation of the assembly including the wall 27, the wheel 18 and the axis 19, relative to the axis 29. When the plunger pushed the axis 19 towards the distributor D, the latter is engaged. When the action of the solenoid relaxes, the spring R pushes back the assembly 18-19-27 which then goes into disengagement. The device can further include a brake 22 which allows to brake the distributor (the toothed wheel 18) when it is disengaged. The solenoid can be controlled by means such as means 12 described above. Such a rotary distributor D can be used in a system as described above in connection with FIGS. 1 and 2.

Preferably, as can be seen in this figure, the output axis 29 of the distributor is aligned with the actuator the actuator means S, 16. There is therefore a vertical alignment, or on the same axis, of the distributor and of the actuator of the actuator means.

When the return spring takes (pushes back) the means 18, 19 in the vertical direction (it pushes them back and therefore moves them away from the distributor), these means are uncoupled from the distributor, but the body of the distributor itself remains in the same position.

In other words, the actuation means S, 16 are located in the axis XX′ of the distributor and can be coupled to, or uncoupled from, the latter without modifying the position of the latter along the vertical axis XX′.

The actuator shown here is of the electromagnetic type. But, another type of actuator, for example of the pneumatic or hydraulic type, can be selected, which, as in FIG. 4, will also be aligned with the output axis 29 of the distributor and will also have a direction of actuation according to the axis XX′; in particular, it will compress the return means (R) to engage the drive means with the distributor, said return means (R) pushing on the contrary the drive means to disengage them relative to the distributor, the latter always keeping the same position along the vertical axis XX′. The actuator moves linearly, along the axis defined by the output axis 29, or mechanical output and/or drive axis, of the distributor. For example, when the actuator is actuated towards the distributor, it compresses the return means; when the actuator is actuated in the opposite direction, in the opposite direction to the distributor, the return means are released and/or return to their rest position.

The toothed wheel, or crown, 18 is not always integral with the distributor: in the disengaged position, it is uncoupled or separated therefrom, depending on the state of the spring (or the return means); here again, the distributor always 5 keeps the same position along the vertical axis XX′.

One application of a system according to the invention relates to the distribution of a flow of cooling water in a cooling circuit of a vehicle. But other applications may be concerned, for example the distribution of oil or gas (for example air or hydrogen) in a vehicle (car or truck, with thermal or electric or 10 hybrid engine; or boat or flying machine), or else the distribution of a fluid in a domestic application, for example a heat pump.

What is claimed is:

1. A system for controlling the distribution of a fluid in a hydraulic circuit, including:
a motor;
a plurality of d rotary distributors of said fluid, each distributor including a body, rotating in a plane, said body including at least one inlet and at least one outlet, the sum of the number of inlets and the number of outlets being greater than or equal to 3, a mechanical output axis of each distributor extending in a direction perpendicular to said plane;
-a plurality of d gear trains, each train ensuring the transmission of the movement of the motor to one of said rotary distributors, called associated rotary distributor, each gear train including means, including an actuator, for engaging or disengaging the associated rotary distributor, relative to the gear train, said actuator moving along the axis defined by the mechanical output axis of the distributor.

2. The system according to claim 1, each gear train including at least two gear stages:
a first stage of gears, each gear of which is driven by said motor;
a second stage of gears, each gear of which is driven by the first stage, a gear being provided with means for engaging it or disengaging it.

3. The system according to claim 1, each rotary distributor including nₑᵢ inlets and nₛᵢ outlets.

4. The system according to claim 1, each rotary distributor including a position sensor.

5. The system according to claim 1, including electronic means for controlling the motor.

6. The system according to claim 5, each rotary distributor including a position sensor, said electronic means being capable of controlling the motor according to a signal or signals from one or more of said position sensors.

7. The system according to claim 5, the electronic means being capable of:
receiving an operating mode instruction;
determining a target position of each of the d rotary distributors;
controlling the motor and the means for engaging or disengaging each rotary distributor according to the target position of each of the rotary distributors.

8. The system according to claim 1, the hydraulic circuit being a distribution circuit for a fluid in a cooling circuit or an oil or hydrogen distribution circuit of a vehicle.

9. The system according to claim 1, the motor being a brushless motor.

10. The system according to claim 1, the means for engaging or disengaging each rotary distributor including an actuator, of electromagnetic, type, for example a coil and a plunger which interacts with the field generated by the coil when a current flows therethrough, or pneumatic or hydraulic type.

11. The system according to claim 1, including, for each rotary distributor:
an axis of rotation which rotates the body of the distributor around said axis;
means for driving said axis of rotation;
return means to maintain the axis of rotation in a disengaged rest position relative to the drive means;
means for disengaging or engaging said axis from its rest position, relative to the drive means.

12. The system according to claim 11, the actuator being capable,
when actuated, of compressing the return means.

13. The system according to claim 11, the axis of rotation which drives the body of the distributor and the means for driving said axis of rotation each including a toothed wheel forming a gear with a vertical axis.

14. The system according to claim 11, further including braking means for braking the distributor when it is disengaged.

15. The system according to claim 11, the return means including a spring held in compression between an axis connected to the rotary distributor and the axis of rotation which drives said body.

16. The system for distributing a fluid in a hydraulic circuit, including:
at least one pump;
a system for controlling the distribution of said fluid according to claim 1.

17. A vehicle including a thermal and/or electric engine, at least one hydraulic circuit and at least one fluid distribution system in the hydraulic circuit according to claim 16.

18. The method for controlling the distribution of a fluid in a hydraulic circuit using a system according to claim 1, including:
selecting one or more rotary distributors to be actuated;
actuating said distributor(s) using the motor and the means for engaging this/these distributor(s).

19. The method according to claim 18, including the selection or determination of a direction and/or an angle of rotation of one or more distributors to be actuated and the actuation of said rotary distributor(s) in this direction and/or this angle of rotation.

20. The method according to claim 18, comprising at least one of the following:
the fluid is water or oil or glycol or a gas, for example air or hydrogen;
the hydraulic circuit is a cooling circuit or oil or hydrogen distribution circuit of a vehicle.

21. (canceled)
